(19) United States
(12) Patent Application Publication
(10) Pub. No.: US 2020/0245569 A1
(43) Pub. Date: Aug. 6, 2020

(54) WATER SPRAY ADAPTER FOR LEAF BLOWER

(71) Applicant: MARC A. ROTH, Sharon Township, OH (US)

(72) Inventor: MARC A. ROTH, Sharon Township, OH (US)

(21) Appl. No.: 16/268,645

(22) Filed: Feb. 6, 2019

(51) Int. Cl. A01G 20/47; B05B 1/30; B05B 15/60; B05B 7/00; B08B 5/02; B08B 3/02; A47L 11/24; A47L 11/40; E01H 1/08

(52) U.S. Cl. CPC A01G 20/47; B05B 1/30; B05B 15/60; B05B 7/0075; B05B 7/2475; B08B 3/026; A47L 11/24; A47L 11/4088; E01H 1/0809; B08B 5/02

(57) ABSTRACT

A backpack blower is provided with a water spray capability to suppress the generation of dust when used as a blower, and to also allow for use as a basic power washer. A leaf blower power unit having an engine driving a fan is interconnected with a wand having an outlet orifice. A spray nozzle is positioned within the wand adjacent the outlet orifice. A source of liquid to be sprayed is interconnected through a control valve to the spray valve such that a spray of water can be introduced into the vortex of the air being emitted from the wand. Both the speed of the airflow and volume of the water being introduced into the vortex may be regulated by the user in accordance with the use to which the unit is put.

### TECHNICAL FIELD

The invention herein resides in the art of blowers employed for moving dirt and debris by subjecting the same to an air stream. More particularly, the invention relates to blowers configured as backpack units that may be employed for blowing leaves and/or other debris from various surfaces by use of a generated air stream forced from a hand-held wand or the like. More specifically, the invention relates to a backpack blower that includes an adapter for introducing water spray into the air stream in such a way as to mitigate the effects of dust or dirt-laden air generated by such blowers by introducing a water spray of a regulatable nature into the air stream used as the force mechanism for removing the dirt and debris. Additionally, the modified backpack blower may be employed as a power washer of sorts employed for light washing of various surfaces.

### BACKGROUND OF THE INVENTION

The utilization of backpack blowers for generating an air stream sufficient in power to blow dirt, debris, leaves and the like has now become commonplace. However, the air stream of such blowers is known to stir up clouds of dust and granular debris and scatter the same rather than provide an effective means for urging such dust and debris to a central area where it can be collected and disposed. This is particularly true when the blowers are used on hard, barren surfaces such as driveways, parking areas, and the like.

Similarly, the use of power washers has become generally known, but such are typically used in association with a powerful stream of water alone, having far more force than is required for cleaning many surfaces.

There is a need in the art for a blower system that entrains water particles within an air stream such as to generate a water mist within the air stream to both contain dust and particulate debris and to also accommodate the washing or cleansing of surfaces not requiring the power of traditional power washers.

In light of the foregoing, it is a first aspect of the invention to provide a water spray adapter for backpack leaf blowers that is capable of introducing a water mist into the vortex of the generated air stream.

A further aspect of the invention is the provision of a water spray adapter for backpack leaf blowers that accommodates regulation of the amount of water introduced into the air stream.

Yet a further aspect of the invention is the provision of a water spray adapter for backpack leaf blowers in which the air stream itself is adjustable.

Still another aspect of the invention is the provision of a water spray adapter for backpack leaf blowers which allows the leaf blower to operate with or without the introduction of water particles into the air stream.

Yet a further aspect of the invention is the provision of a water spray adapter for backpack leaf blowers that is readily adapted for implementation with presently known backpack leaf blowers.

Still a further aspect of the invention is the provision of a water spray adapter for backpack leaf blowers in which additives may be included in the water introduced into the air stream.

Still another aspect of the invention is the provision of a water spray adapter for backpack leaf blowers that accommodates use as a device for generating an air/water stream to direct dust, dirt and debris to a particular location and to alternatively serve as simply a light-duty pressure washer for removing dust and dirt from a surface in a slurry.

An additional aspect of the invention is the provision of a water spray adapter for backpack leaf blowers which is easy to construct with state-of-the-art materials and devices.

### SUMMARY OF THE INVENTION

The foregoing and other aspects of the invention that will become apparent as the detailed description proceeds are achieved by a backpack blower with water spray capability, comprising: a leaf blower power unit having an engine driving a fan, said fan being in communication with a wand having an outlet orifice; a spray nozzle within said wand adjacent said outlet orifice; a source of liquid to be sprayed; and a control valve interposed between said spray nozzle and said source of liquid.

Other aspects of the invention which will become apparent herein are achieved by a water spray adapter for a backpack blower, comprising: an inlet tube; an outlet tube; a valve interposed between said inlet and outlet tubes; and a spray nozzle connected to a first end of said outlet tube opposite a second end of said outlet tube connected to said valve.

### DESCRIPTION OF THE DRAWINGS

For a complete understanding of the various aspects and features of the invention, reference should be made to the following detailed description and accompanying drawings wherein:

FIG. 1 is a perspective view of a leaf blower having a water spray adapter made in accordance with the invention;

FIG. 2 is a perspective view of the outlet orifice of the blower wand showing the placement of a spray nozzle therein;

FIG. 3 is a perspective view of the control arm of the blower receiving the water control valve of the adapter by means of an interconnecting bracket; and

FIG. 4 is a perspective view of the assembly of FIG. 3, from the opposite side, showing the water control valve and associated valve lever.

### BEST MODE FOR CARRYING OUT THE INVENTION

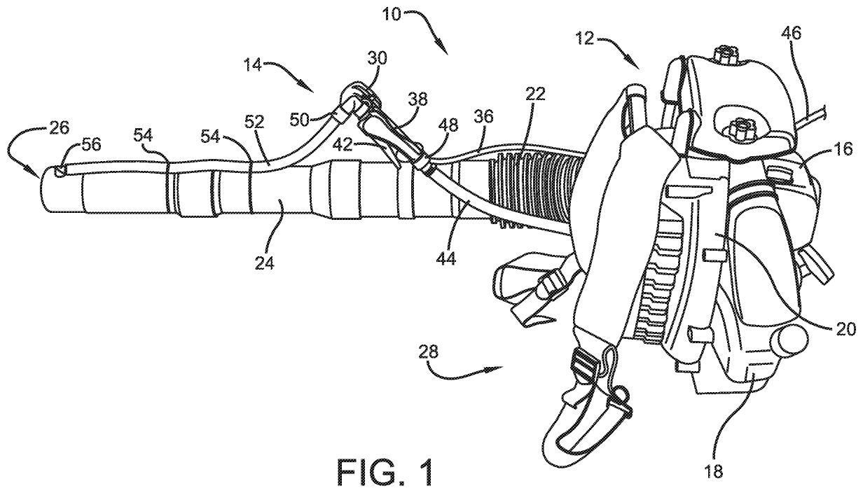

Referring now to the drawings and more particularly FIG. 1, it can be seen that a leaf blower with a water spray adapter, made in accordance with the invention, is designated generally by the numeral 10. The assembly 10 consists of a leaf blower power unit and hose assembly 12 and a water or other liquid spray adapter 14.

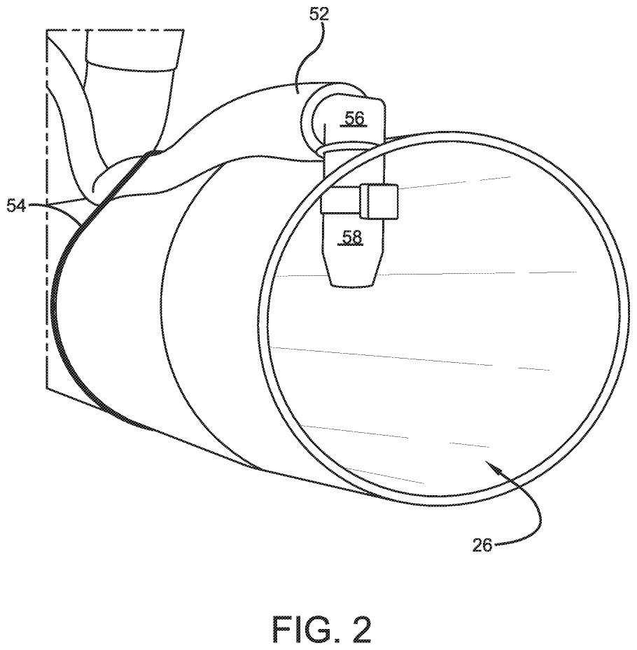

As shown, the leaf blower power unit and hose assembly 12 consists of an engine 16 fueled by an appropriate source such as gasoline retained in and fed from a fuel tank 18. A fan assembly 20 consists of a housing retaining a fan therein driven by the engine 16 and exhausting high-pressure air through the flexible pipe 22 to a rigid pipe or wand 24. It will be appreciated that the flexible pipe 22 accommodates maneuverability of the wand 24 to direct the air stream to an appropriate target area. The wand 24 has an outlet orifice 26, shown in FIGS. 1 and 2, out of which a stream of fast-moving and high-pressure air is emitted, typically having a vortex at the center thereof.

With further reference to FIG. 1, it can be seen that an adjustable harness 28 is provided in interconnection with the assembly 10 to allow a user to receive and carry the assembly 10 as a “backpack” unit. As is well known in the art, such a unit is supported by the shoulders of the user, rests against his/her back, and is secured about the waist/chest.

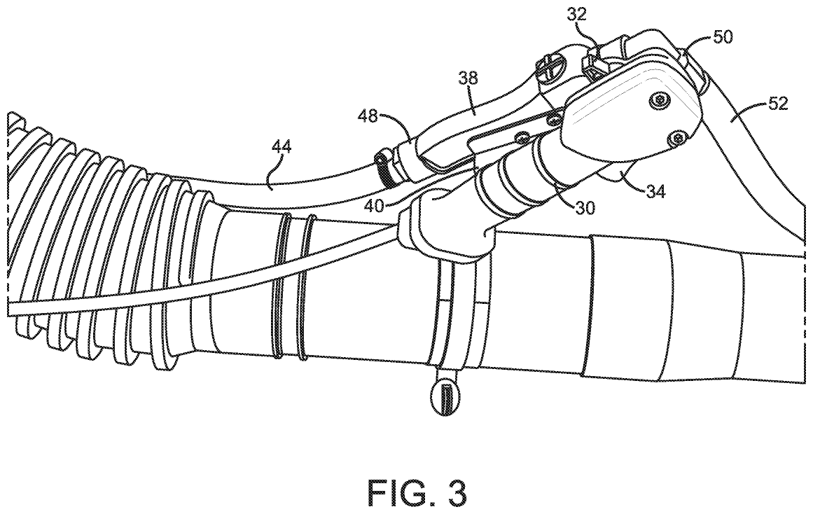

With the backpack in place, the user may hand-engage a control arm 30 (FIGS. 1 and 3) that is securedly mounted to the wand 24, typically in the range of “arm's length” engagement. The control arm allows the user to manipulate the wand 24 as accommodated by the flexible pipe 22. A choke/run/kill selector 32 is mounted near the top of the control arm 30 and accommodates starting and stopping of the engine 16. A throttle trigger 34, best shown in FIG. 3, is also maintained on the control arm 30 to engage and control the throttle of the engine 16 through an appropriate control cable 36. It will be appreciated that the throttle trigger 34 is preferably of the locking type, allowing the throttle to be set at a desired level, resulting in continuous operation of the engine 16 at a desired speed. The control cable 36 interconnects with the carburetor and also with the spark generator or the spark plug(s) for shutting off the engine 16 when desired.

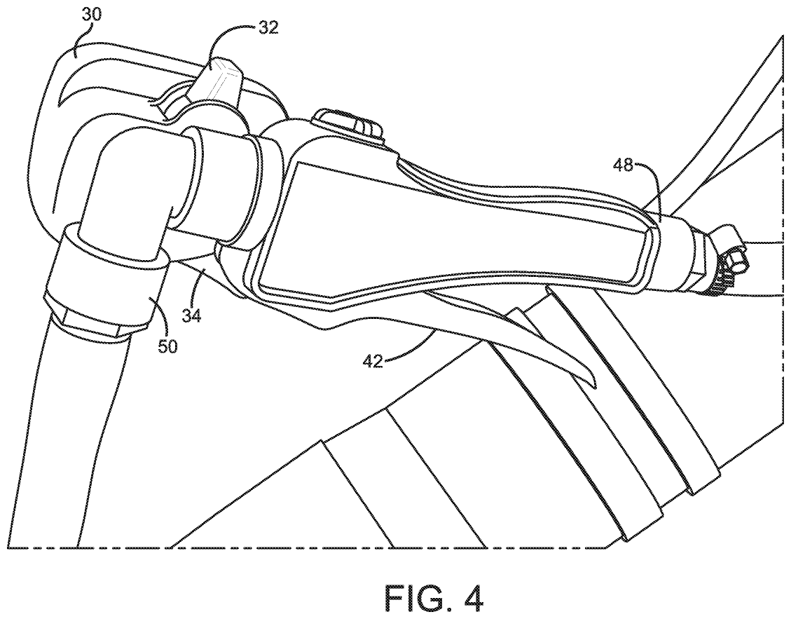

With reference to FIGS. 1, 3 and 4 it can be seen that a water control valve 38 is mounted by an appropriate bracket or the like to be operatively and removably connected to the control arm 30. While the control valve 38 is referred to as a water control valve, it will be appreciated that the concept of the invention may accommodate the use of water alone, or water modified by various additives such as detergents, spotless surfactants, wax, and the like. While it is also presented that the water control valve 38 may be removably attached to the control arm 30 by means of a bracket 40, the invention also contemplates that the control valve 38 be formed integrally with the control arm 30 in the event removability of the water spray adapter is not desired.

A valve lever 42 actuates and regulates the water control valve 38 by hand pressure applied thereto, regulating the degree that the valve 38 is open. The lever 42 is of the type that may be selectively locked in any of various states of actuation as by an appropriate retainer or the like. Accordingly, the user may select air speed by locking of the trigger 34 and the amount of water introduced into the air stream (as will be discussed below) by means of the locking valve lever 42.

An inlet tube 44 is connected to an inlet side of water control valve 38 and is adapted for interconnection with an appropriate supply of liquid, such as water, as through a hose or other appropriate means. Again, it will be appreciated that the valve 38 may regulate the flow of plain water, detergent-treated water, “spot-free” water, wax or the like. In any event, the inlet tube 44 is adapted for appropriate interconnection with a feed hose 46, which in turn connects to the appropriate desired liquid source. An inlet connector 48 is provided on the inlet side of the valve 38, preferably threaded to the valve itself and clamped by means of an appropriate hose clamp to inlet tube 44.

On the outlet side of the water control valve 38, an outlet connector 50, such as an elbow connector, is threaded to the housing of the valve 38 and clamped to an outlet tube 52 that is secured to the rigid pipe or wand 24 along its outer surface by appropriate zip ties 54 or similar means for secured engagement. The invention further contemplates that molded receptacles may be provided along the wand 24 to receive the outlet tube 52 in a snap-fit engagement. At the opposite end of the outlet tube 52 is an elbow connector 56 that passes into the interior of the wand 24 near the end thereof. As best shown in FIG. 2, a spray nozzle 58 is connected to the elbow connector 56 and extends such that its spray opening is in juxtaposition to the vortex of the air spray that will be passing through the wand 24. Additionally, the spray nozzle 50 is positioned within 1-5 inches, and most preferably in the range of 2 inches, from the orifice 26 or end of the wand 24. In a preferred embodiment, the spray nozzle 50 is back-cut on the order of 20°-40°, and most preferably 30°, to introduce the water spray into the oncoming air stream. Other spray geometries may be utilized, as may various droplet sizes be employed.

With the system just described, it will be appreciated that an operator can regulate and/or set the airflow speed of the air passing through and out of the wand 24, as well as the volume of water being sprayed into the vortex of that air stream. Different speeds and volumes are desired, depending upon the use to which the unit 10 is placed. It is contemplated that the unit 10 may be used for blowing debris, leaves, and the like as is customary, with the water entrained within the air serving to settle dust and small particulate matter, which would otherwise be stirred by the forceful air flow across the surface being cleared. The unit 10 is also contemplated as being used as a low-pressure spray washer, which may be used for spraying off parking lots, drive surfaces, and the like. It may also be used for spraying off building siding, lawn furniture, and the like. An additional use is that of spraying off vehicles on a car lot, in which case a detergent and/or spot-free surfactant and/or wax may be placed into the water to leave vehicles with a clean, shiny, spot-free appearance.

Thus it can be seen that the various aspects of the invention have been achieved by the system presented and described above. While in accordance with the patent statutes only the best mode and preferred embodiment of the invention has been presented and described in detail, the invention is not limited thereto or thereby. Accordingly, for an appreciation of the scope and breadth of the invention reference should be made to the following claims.

What is claimed is:

1. A backpack blower with water spray capability, comprising:
a leaf blower power unit having an engine driving a fan, said fan being in communication with a wand having an outlet orifice;
a spray nozzle within said wand adjacent said outlet orifice;
a source of liquid to be sprayed; and
a control valve interposed between said spray nozzle and said source of liquid.

2. The backpack blower with water spray capability as recited in claim 1, further comprising a control arm connected to said wand and operatively interconnected with said engine.

3. The backpack blower with water spray capability as recited in claim 2, wherein said control valve is maintained adjacent said control arm.

4. The backpack blower with water spray capability as recited in claim 3, wherein said control valve is lever actuated and controlled.

5. The backpack blower with water spray capability as recited in claim 4, wherein said lever of said control valve is lockable to maintain said control valve in selected states of actuation.

6. The backpack blower with water spray capability as recited in claim 5, wherein said control arm is selectively operably interconnected with and controls a throttle of said engine.

7. The backpack blower with water spray capability as recited in claim 6, wherein said control valve is mounted to said control arm.

8. The backpack blower with water spray capability as recited in claim 7, wherein said spray nozzle is in communication with a vortex of an air stream within said wand at said outlet orifice.

9. The backpack blower with water spray capability as recited in claim 3, wherein said liquid to be sprayed is water.

10. The backpack blower with water spray capability as recited in claim 9, wherein said water contains an additive taken from the group of detergent, spotless surfactant, and wax.

11. A water spray adapter for a backpack blower, comprising:
an inlet tube;
an outlet tube;
a valve interposed between said inlet and outlet tubes; and
a spray nozzle connected to a first end of said outlet tube opposite a second end of said outlet tube connected to said valve.

12. The water spray adapter for a backpack blower as recited in claim 11, wherein said valve is adapted for connection to a control arm on a wand of a backpack blower.

13. The water spray adapter for a backpack blower as recited in claim 12, further comprising a bracket interconnecting said valve and control arm.

14. The backpack blower with water spray capability as recited in claim 13, further comprising means for selectively securing said outlet tube to a wand of a backpack blower.

15. The backpack blower with water spray capability as recited in claim 14, wherein said spray nozzle extends orthogonally to a longitudinal axis of said outlet tube.

16. The backpack blower with water spray capability as recited in claim 15, wherein said spray nozzle is configured to communicate with a vortex of an air stream generated by the backpack blower.

17. The backpack blower with water spray capability as recited in claim 12, wherein said valve comprises an activating lever adapted to be locked at levels of activation selected by an operator.
